(19) United States
(12) Patent Application Publication
(10) Pub. No.: US 2007/0066476 A1
(43) Pub. Date: Mar. 22, 2007

(54) Centrifuge comprising a separator disc stack and separator disc

(75) Inventors: Detlef Ullmann, Oelde (DE); Knud Schoneberg, Stade (DE)

Correspondence Address: BARNES & THORNBURG LLP, 750-17TH STREET NW, SUITE 900, WASHINGTON, DC, 20006-4675, US

(73) Assignee: WESTFALIA SEPARATOR AG, Oelde (DE)

(21) Appl. No.: 10/563,654

(22) PCT Filed: Jul. 8, 2004
(86) PCT No.: PCT/EP04/07480

§ 371 Date: Jun. 13, 2006

(30) Foreign Application Priority Data
Jul. 10, 2003 (DE) 103 31 424.5
Dec. 12, 2003 (DE) 103 58 239.8

(51) Int. Cl. B04B 1/08; B04B 7/14

(52) U.S. Cl. 494/70

(57) ABSTRACT

The present disclosure relates to a method of increasing the separation effect of a centrifuge having separator discs in a disc stack. Also, the present disclosure relates to a separator disc and a centrifuge.

### BACKGROUND AND SUMMARY

The present disclosure relates to a centrifuge having a centrifugal drum and to a stack of separator discs. The present disclosure also relates to separator discs.

Separator discs are conventionally made of high-grade steel. An achievable separation effect when separating a product, such as water or oil, into two phases deserves to be improved.

It is known to pretreat the metal surface of a standard material of the separator discs, for example, by an electrical or manual polishing operation. Although these measures counteract a contamination of the separator discs, they do not significantly increase the separation effect.

The present disclosure relates to increasing the separation effect of a centrifuge of the above-mentioned type in a constructively simple manner when a product is separated into at least two phases, and to also improve the cleaning action of the separator discs.

Accordingly, the separator discs, according to the present disclosure, are, at least in sections, subjected to a surface treatment changing the surface energy.

The present disclosure also creates a separator disc for a centrifuge which, at least in sections, is subjected to a surface treatment changing the surface energy.

As a result, the separating performance or the separation effect is significantly increased or optimized in a constructively simple manner because, by the surface treatment changing the surface energy, the separating performance or separation effect can be adapted precisely to the respective product. That is, the surface energy of the separator discs is changed in a targeted fashion such that, for example, an oil-friendly and a water-unfriendly surface occurs simultaneously. The surface treatment also increases the cleaning capacity of the separator discs.

The separator discs include a first material which, at least in sections, is provided with at least one coating which changes the surface energy in comparison to the first material and is made of at least one other material. This measure can be implemented by a method of subjecting separator discs at least in sections to a surface treatment changing the surface energy.

As an alternative or option, it is also possible for the separator discs to include a material into which, at least in sections, another material is diffused, which changes the surface energy in comparison to the first material. For example, this can be done by a method similar to surface-treating methods of the semiconductor technology, for example, by a plasma jet or the like. In an alternative manner, this also results in changing the surface energy.

Combinations of the two above-mentioned methods are also conceivable.

The surface treatment may, therefore, result in chemical and/or physical bonding between the surface and the applied or inserted material.

Also for reasons of a simpler producibility, the separator discs may be surface-treated at a top and/or bottom side in a completely surface-energy-changing manner. That is, for example, being provided with the coating.

It is also conceivable that different surface treatments may be carried out for the adaptation to respective phases of a material or product to be separated in the different areas of the separator discs which separator discs may be made of high-grade steel.

In the case of a centrifuge or separator, each separator disc may be divided into several function areas or sections in order to achieve an optimization of the value phase. In this case, the surface treatments, for example, the coating materials, can be adapted to the surface energy of the light or heavy phases to be separated.

It is also conceivable to carry out different surface treatments above and below the separator discs, or radially inside and outside the separation zone, particularly radially inside and outside a rising duct which is often arranged such that the separation zone is situated in its center.

Other aspects of the present disclosure will become apparent from the following descriptions when considered in conjunction with the accompanying drawings.

### BRIEF DESCRIPTION OF THE DRAWINGS

FIG. 1 is a schematic representation of a method of operation of separator discs according to the present disclosure, and ian example of a coating on the separator disc.

FIG. 1 should be understood to be an example of a treatment. Instead of being generated by surfaces coatings, a changing of surface energy can also be generated by other types of treatment, such as by diffusing another material into the material of the separator discs.

FIG. 2 shows a representation of an uncoated portion of a separator disc, including a water drop.

FIG. 3 shows a representation of a coated separator disc, according to the present disclosure, and including a water drop.

### DETAILED DESCRIPTION

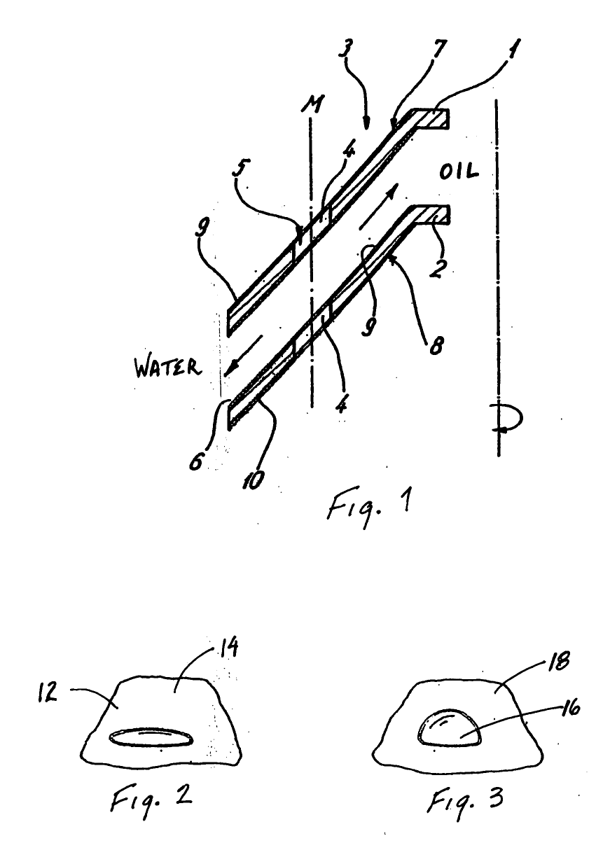

FIG. 1 shows two conical separator discs 1, 2 of a separator disc stack 3 for a separator. Disc stack 3 may include additional discs 1, 2. The separator discs 1,2 each have openings 4 which, interacting with one another, form a rising duct 5. The separator discs 1, 2 are axially spaced from one another, so that a gap 6 is formed between them.

An example of a separator disc stack is shown, for example, in German Patent Document DE 36 07 526 A1 or DE-OS 19 09 996. The separator discs 1, 2 generally are made of high-grade steel.

The disk stack 3 of the present disclosure differs from the disc stack referenced in the above-mentioned references in that upper and lower (as viewed in FIG. 1) surfaces 7, 8 of the separator discs 1,2 are provided completely or to a significant part, that is on more than 50% of their surface, with a coating 9, 10 which changes the surface energy relative to a metal disc. This coating 9, 10 may, for example, have a ceramic construction and/or may be constructed on a Teflon base and/or may be constructed as a lacquer, for example, it may be silicious, silicon lacquer, or the like. The coating 9, 10, depending on the usage, may be applied to the top and/or bottom side of the separator discs, 1, 2, either completely or in sections.

As a result of the coating 9, 10 of the separator discs 1, 2, their surface can be further developed, for example, to be unfriendly with respect to water but friendly with respect to oil.

When a dispersion flows into the separator disc gap 6, the dispersion separates into two phases, that is, “water” on the left of center M of the rising duct 5 and “oil” on the right of the center M of the rising duct 5, as shown in FIG. 1. The water includes a small residual fraction of “oil” in the form of drops which are to be removed in the separator disc stack 3. The drops of oil adhere better on the oil-friendly separator disc surface on contact than the other phase and coalesce with other drops and form an oil film. As a result of centrifugal force, some oil moves to the side of the light or lighter phase (oil).

During the separation in the separator disc gap 6, oil drops are formed on the water side and water drops are formed on the oil side. Thus, different demands are made on the surfaces of the discs 1, 2. The water side should be oil-friendly so that the residual oil drops coalesce better on the surface, while the oil side should have precisely the opposite characteristics. It can be derived therefrom that the separator discs 1, 2 can be divided into several function surfaces or sections with different coatings, shown in FIG. 1 as coatings 9, 10.

The coatings 9, 10 are divided in different areas. That is, in the area of the lighter phase, the coating is adapted to the lighter phase, so that mainly this lighter phase adheres to the separator discs 1, 2. However, in the area of the heavy phase, it is adapted to the heavy phase so that this heavy phase adheres more to the separator discs 1, 2.

It not only becomes possible to adapt the coating 9, 10 or the surface energy of the coating 9, 10 of the separator discs 1, 2 in the different areas to the different phases to be separated from one another, but it also becomes possible to adapt the surface energy to the centrifugal material to be processed. That is, the coating selected, for example, for the separation of an water/oil mixture should differ from the one selected for separating other liquids.

The result is an achievable reduction of wear as well as lower friction values and an increase of the resistance to corrosion.

An experiment has shown that a bilge water separation into oil and water, as carried out onboard a ship, can achieve a clear increase of performance.

FIG. 2 shows a flattened shape of a water drop 12 on an uncoated separator disc 14. FIG. 3 shows a water drop 16 on a coated separator disc 18, which water drop 16 is not as wide as the water drop 12 in FIG. 2. Water drop 16 is higher but has the same volume, which is promoted by a selected coating of the separator disc 18. The following is noted concerning the theory of coatings. In addition to surface structure, the surface energy is a criterion for adhesions. The treatment of separator discs by polishing changes the surface energy only slightly but does not generate a so-called non-stick layer. A reduction of adhesions can be explained by an implemented change of the structure. The surface energy of the separator discs 1, 2 is situated in an area of an adhesive layer and is water-friendly.

The phenomenon of the free interfacial energy can be explained thermodynamically. For a given system, the proportional action factor between its energy and its interface is the so-called interfacial tension or, more precisely, the “free interfacial energy”. In order to enlarge the interface of a system, work must be carried out. The free surface energy is additively composed of the dispersive and non-dispersive (polar) energies or interactions.
σ=σ^{P}+σ^{D}
σ^{P}=non-dispersive (polar fractions of interfacial energy)
dipole-dipole interaction
hydrogen bonding
Lewis acid/base interaction
charge-transfer interaction
σ^{D}=dispersive fraction of interfacial energy
Van der Waals interaction

Each atom or molecule has dispersive forces which are generated because of the local and temporary fluctuation of the electron sheath density. The non-dispersive (polar) forces are a plus which, because of special (for example, functional) groups, contributes to the total interaction.

If a treated solid is to be brought in contact with a liquid, which occurs during lacquering, gluing, cleaning, wetting of a liquid on a surface, etc., the surface energy of the solid in the case of a given liquid is the wanted value for determining the surface energy. Thus, according to the present disclosure, it is also advantageous in the area of the separator discs 1, 2 for a liquid to exactly match the corresponding parameters of the solid with respect to its surface tension, because, in the event that the energy of the solid is too low, the surface parts are wetted less.

In most cases, the adhesion can be explained directly by means of the surface energies of the two adhesion partners. For this purpose, it is especially necessary to know the polar fraction. A simple criterion for an optimal adhesion is a complete compatibility from an energetic point of view as well as the presence of a polar fraction, which is as large as possible, on both sides. It follows that the total surface energies, that is, the dispersive as well as particularly also the polar fractions of the two phases, should be identical in order to achieve a complete wetting of the oil. For a non-stickiness, a surface energy which is as low as possible is required, together with a small polar fraction.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A method of increasing the separation effect of a centriftige having separator discs in a disc stack, the method step comprising:
providing separator discs having a surface energy; and
treating at least one surface of the separtor discs, the treating being done at least in sections of the separator discs, thereby changing the surface energy of the separator discs.

2. The method according to claim 1, wherein the separator discs include a first material having the surface energy which first material, at least in sections, is treated with at least one coating that includes at least one other material, and which coating changes the surface energy of the separator discs.

3. The method according to claim 1, wherein the separator discs include a material having a surface energy and into which, at least in sections, another material is diffused, which diffusion changes the surface energy of the separator discs.

4. The method according to claim 1, wherein the treating of the separator discs includes completely treating one or both of the top and bottom surfaces of the separator discs.

5. The method according to claim 1, wherein the centrifuge is configured to separate a product into phases, and the treating of the separator discs is adapted to the surface energy of the phases be separated.

6. The method according to claim 2, wherein the first material includes high-grade steel and the at least one coating is ceramic.

7. The method according to claim 1, wherein the treating includes different materials applied as coatings to or diffused into sections of the separating discs.

8. The method according to claim 1, wherein the treating changing the surface energy done to surfaces above and below the separating discs.

9. The method according to claim 1, wherein the treating is done to surfaces of the discs radially inside and outside separating zone.

10. The method according to claim 1, wherein the treating is done to the separator discs radially inside and outside a rising duct.

11. A separator disc for a centrifuge, the separator disc comprsing:
at least two surfaces having sections; and
wherein the at least two surfaces include a treatment changing the surface energy of one or more of the sections of the separator discs.

12. A centrifuge, comprising:
a centrifugal drum for separating a product into phases;
a separator disc stack in the centrifugal drum, the disc stack including separator discs; and
the separator discs including a treatment, at least in sections, such that the surface energy of the separator discs is changed.
